(19) United States
(12) Patent Application Publication
(10) Pub. No.: US 2025/0379373 A1
(43) Pub. Date: Dec. 11, 2025

(54) CONNECTOR ASSEMBLY AND TERMINAL

(71) Applicant: Tyco Electronics (Shanghai) Co., Ltd., Shanghai (CN)

(72) Inventors: Wenfang (Felix) Zhang, Shanghai (CN); Yongjian (Justin) Huang, Shanghai (CN); Tongbao (Tim) Ding, Shanghai (CN); Chunjie Hu, Shanghai (CN); Zhimin Zhang, Shanghai (CN)

(73) Assignee: Tyco Electronics (Shanghai) Co., Ltd., Shanghai (CN)

(21) Appl. No.: 19/233,450

(22) Filed: Jun. 10, 2025

(30) Foreign Application Priority Data
Jun. 11, 2024 (CN) 202410749736.2

(51) Int. Cl. H01R 4/2433

(52) U.S. Cl. CPC H01R 4/2433

(57) ABSTRACT

A connector assembly includes a terminal having a wire connecting portion electrically connectable with a wire and a limiting portion disposed on a side of the wire connecting portion. The connector assembly includes a connector housing with a body having an accommodating channel accommodating the terminal and a cover movably disposed on the body with a blocking portion disposed on the cover. The cover is movably operated such that the blocking portion is opposite to the limiting portion, fixing the wire between the blocking portion and the limiting portion.

### CROSS-REFERENCE TO RELATED APPLICATIONS

This application claims the benefit of the filing date under 35 U.S.C. § 119(a)-(d) of Chinese Patent Application No. 202410749736.2, filed on Jun. 11, 2024.

### FIELD OF THE INVENTION

The present disclosure relates to the technical field of electrical connection, in particular to a connector assembly and a terminal.

### BACKGROUND OF THE INVENTION

A connector assembly for electrical connection generally includes a connector housing and a connective terminal. The connective terminal is used for connecting to an external wire. The connector housing is configured to accommodate the connective terminal therein.

An insulated sheath of the wire generally needs to be manually stripped, and then the wire with a metal core exposed can connect with the terminal. In addition, the step of fixing the wire in the terminal also needs to be completed manually. The manual processing consumes significant manpower and time, and is not conducive to industrial automation assembly.

### SUMMARY OF THE INVENTION

A connector assembly includes a terminal having a wire connecting portion electrically connectable with a wire and a limiting portion disposed on a side of the wire connecting portion. The connector assembly includes a connector housing with a body having an accommodating channel accommodating the terminal and a cover movably disposed on the body with a blocking portion disposed on the cover. The cover is movably operated such that the blocking portion is opposite to the limiting portion, fixing the wire between the blocking portion and the limiting portion.

### BRIEF DESCRIPTION OF THE DRAWINGS

Features, advantages, and other aspects of embodiments of the present disclosure will become more apparent from the following detailed description with reference to the accompanying drawings. Several embodiments of the present disclosure are shown therein by way of example and not limitation. In the drawings:

FIG. 1 shows a schematic view of a terminal according to an embodiment of the present disclosure;

FIG. 2 shows a schematic view of a connector housing according to an embodiment of the present disclosure;

FIG. 3 shows an assembly schematic view of a terminal and a connector housing according to an embodiment of the present disclosure, which includes an enlarged partial view M sectioned along Plane AA;

FIG. 4 shows another assembly schematic view of a terminal and a connector housing according to an embodiment of the present disclosure, which includes an enlarged partial view N sectioned along Plane BB and an enlarged partial view L sectioned along Plane CC;

FIG. 5 shows a schematic view of a terminal clamping a wire according to an embodiment of the present disclosure;

FIG. 6 shows a schematic structural view of a terminal from a bottom perspective, according to an embodiment of the present disclosure;

FIG. 7 shows another assembly schematic view of a terminal and a connector housing according to an embodiment of the present disclosure; and

FIG. 8 shows another assembly schematic view of a terminal and a connector housing according to an embodiment of the present disclosure.

### DETAILED DESCRIPTION

In the following detailed description of the embodiments, reference is made to the accompanying drawings, which form a part of the present disclosure. The accompanying drawings show, by way of illustration, specific embodiments in which the present disclosure can be realized. The exemplary embodiments are not intended to exhaust all embodiments of the present disclosure. In the specification, same or similar reference numerals indicate same or similar components. It should be understood that other embodiments may be utilized and structural modifications may also be made without departing from the scope of the present disclosure. Therefore, the following detailed description is not limiting, and the scope of the present disclosure is defined by the appended claims.

The terms “includes”, “comprises” and the like used in the present disclosure should be interpreted as open-ended terms, i.e., “includes/comprises but is not limited to”, indicating that other elements may also be included. The term “one embodiment” indicates “at least one embodiment”. The term “another embodiment” indicates “at least one additional embodiment”.

It should be understood that the specific embodiments discussed are merely illustrative of specific ways to implement and utilize the present invention, and are not to be construed as a limitation to the scope. Expressions such as upper, lower, left, right, top, and bottom used in describing the components are not absolute, but relative. When the components are arranged as shown in the drawings, these expressions are appropriate, but when the positions of the components in the drawings are changed, these expressions are changed accordingly.

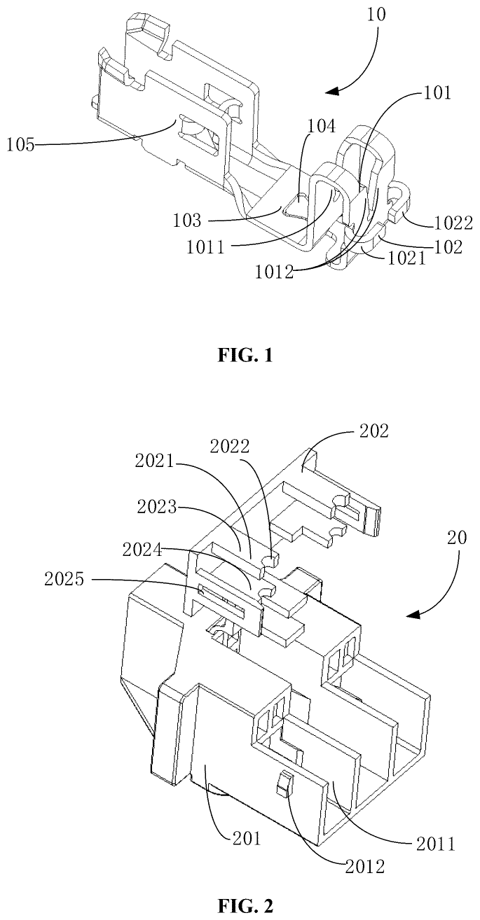

The present disclosure provides a connector assembly including a terminal 10 and a connector housing 20, shown in an embodiment in FIGS. 1 and 2. The terminal 10, shown in FIG. 1, may be made of a metal such as copper, and the connector housing 20, shown in FIG. 2, may be made of plastic.

The terminal 10 is configured to connect a wire, and includes a wire connecting portion 101 and a limiting portion 102 shown in FIG. 1. The wire connecting portion 101 can be used for electrical connection with the wire, and the limiting portion 102 is disposed on a side of the wire connecting portion 101.

The connector housing 20, as shown in FIG. 2, includes a body 201 and a cover 202. The body 201 includes an accommodating channel 2011 configured to accommodate the terminal 10. The cover 202 is movably disposed on the body 201, and a blocking portion 2021 is disposed on the cover 202.

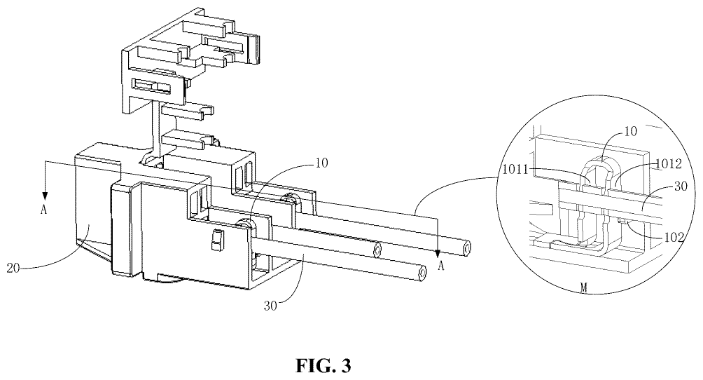

FIG. 3 shows an assembly schematic view of the terminal 10 and the connector housing 20 according to an embodiment of the present disclosure, which includes an enlarged partial view M sectioned along Plane AA. Referring to FIG. 3, the connector housing 20 can accommodate the terminal 10 therein that has connected with a wire 30, and the limiting portion 102 of the terminal 10 limits the lower surface of the wire 30.

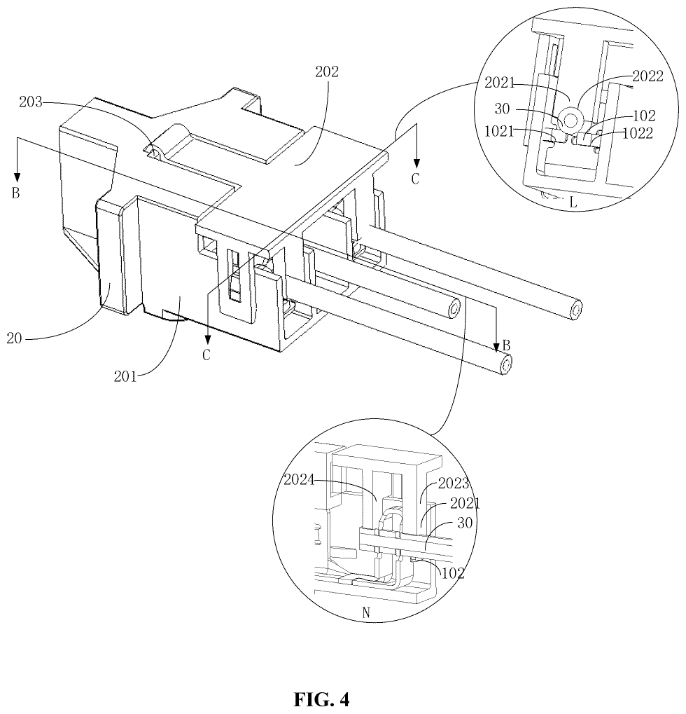

FIG. 4 shows another assembly schematic view of a terminal 10 and a connector housing 20 according to an embodiment of the present disclosure, which includes an enlarged partial view N sectioned along Plane BB and an enlarged partial view L sectioned along Plane CC. Referring to FIG. 4, the cover 202 of the connector housing 20 is movably operated such that the blocking portion 2021 of the housing 20 is opposite to the limiting portion 102, thereby fixing the wire 30 between the blocking portion 2021 and the limiting portion 102. Specifically, the cover 202 of the connector housing 20 can be flipped down, and the blocking portion 2021 located on the cover 202 limits the upper surface of the wire 30. The combination of the limiting portion 102 and the blocking portion 2021 can prevent the wire 30 from moving in the vertical direction.

In this embodiment, referring to FIG. 1 and the view L in FIG. 4, the limiting portion 102 includes a first limiting arm 1021 and a second limiting arm 1022 that are oppositely distributed. At least a portion of a distance between the first limiting arm 1021 and the second limiting arm 1022 is less than a diameter of the wire 30, thereby preventing the wire 30 from moving downward. In other embodiments, the limiting portion 102 may be any other suitable structure as long as it can limit the lower surface of the wire 30. For example, the first limiting arm 1021 in the limiting portion 102 can be connected to the second limiting arm 1022.

In this embodiment, referring to FIG. 2 and the view L in FIG. 4, the blocking portion 2021 includes an arcuate notch 2022 disposed at an end of the blocking portion 2021. The arcuate notch 2022 can be adjacent to the upper surface of the wire 30 as much as possible to increase the contact area and improve the blocking effect. In other embodiments, the blocking portion 2021 may not include the arcuate notch 2022, and any other suitable structure may be used as long as it can prevent the wire 30 from moving upward.

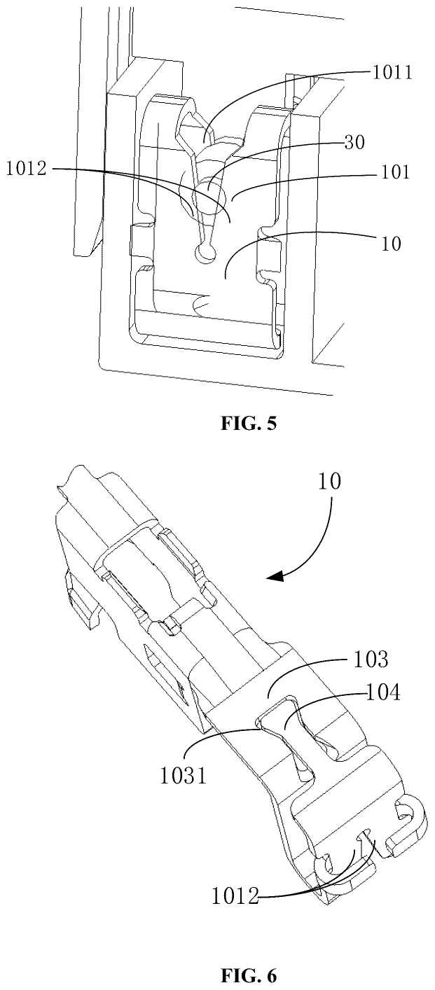

FIG. 5 shows a schematic view of a terminal clamping a wire according to an embodiment of the present disclosure, and the view hides the limiting portion of the terminal 10 to facilitate observation to the structure of the terminal 10 used for clamping the wire 30. It can be seen that the wire connecting portion 101 of the terminal 10 includes a first pair of blade-type sub-arms 1011 distributed oppositely. The spacing between the first pair of blade-type sub-arms 1011 gradually decreases downward. When the wire 30 goes between the first pair of blade-type sub-arms 1011 (for example, by manual wire pressing or automatic wire pressing), the first pair of blade-type sub-arms 1011 achieves a piercing-type electrical connection with the wire 30 and clamps the wire 30 therebetween, to prevent the wire 30 from moving in a horizontal direction.

In this embodiment, referring to FIG. 1, the view M in FIG. 3, and FIG. 5, the wire connecting portion 101 further includes a second pair of blade-type sub-arms 1012 oppositely distributed. The second pair of blade-type sub-arms 1012 are disposed along the extending direction of the wire 30 relative to the first pair of blade-type sub-arms 1011. The spacing between the second pair of blade-type sub-arms 1012 gradually decreases downward. When the wire 30 goes between the second pair of blade-type sub-arms 1012, the second pair of blade-type sub-arms 1012 achieves a piercing-type electrical connection with the wire 30 and clamps the wire 30 therebetween. This embodiment arranges for the wire connecting portion 101 to be a structure having two pairs of blade-type sub-arms 1011, so that the terminal 10 can clamp the wire 30 at a plurality of contact points to maintain a straight form of the wire. It should be noted that, in other embodiments, the wire connecting portion 101 may not include the second pair of blade-type sub-arms 1012.

FIG. 6 shows a schematic structural view of a terminal from a bottom perspective according to an embodiment of the present disclosure. Referring to FIGS. 1 and 6, the terminal 10 further includes a terminal body 103 with a dovetail groove 1031 disposed thereon and a dovetail tenon 104. The terminal body 103 with the dovetail groove 1031 disposed thereon is directly connected to the first pair of blade-type sub-arms 1011, and the dovetail tenon 104 is directly connected to the second pair of blade-type sub-arms 1012. The dovetail tenon 104 is embedded in the dovetail groove 1031 such that the second pair of blade-type sub-arms 1012 are fixed relative to the first pair of blade-type sub-arms 1011. For example, the mating structure of the dovetail groove 1031 and the dovetail tenon 104 makes the spacing between the first pair of blade-type sub-arms 1011 and the second pair of blade-type sub-arms 1012 substantially unchanged.

Referring to FIG. 2 and the view N in FIG. 4, the blocking portion 2021 includes a first blocking portion 2023 and a second blocking portion 2024, wherein the second blocking portion 2024 is disposed along the extending direction of the wire 30 relative to the first blocking portion 2023. For example, under the condition that temperature changes, the shape of the wire 30 may change due to the thermal expansion and contraction effect, and for another example, the user may pull or move the wire 30 during use. In these cases, the arrangement of two blocking portions can enhance the fixing effect on the wire 30.

In the embodiment of FIG. 4, the cover 202 of the connector housing 20 is connected to the body 201 through a hinge. The connector housing 20 further includes a hinge shaft 203, wherein the cover 202 is movably connected to the body 201 via the hinge shaft 203. This enables the cover 202 to change from the state shown in FIG. 2 to the state shown in FIG. 4 after it is flipped down, and the cover 202 remains connected to the body 201 all the time, which is convenient for the user to use. In other examples, the movable connection between the cover 202 and the body 201 may be other suitable manners easily conceived by those skilled in the art, such as threaded connection. In addition, in this embodiment, the connector housing 20 is integrally formed via a mold (e.g., via an injection molding process).

Further, referring to FIG. 2, the cover 202 includes a snap-fit portion 2025 (e.g., a snap-fit groove) disposed thereon, and the body 201 includes a snap-fit mating portion 2012 (e.g., a hook structure) disposed thereon. The snap-fit portion 2025 is configured to cooperate with the snap-fit mating portion 2012 to fix the cover 202 to the body 201.

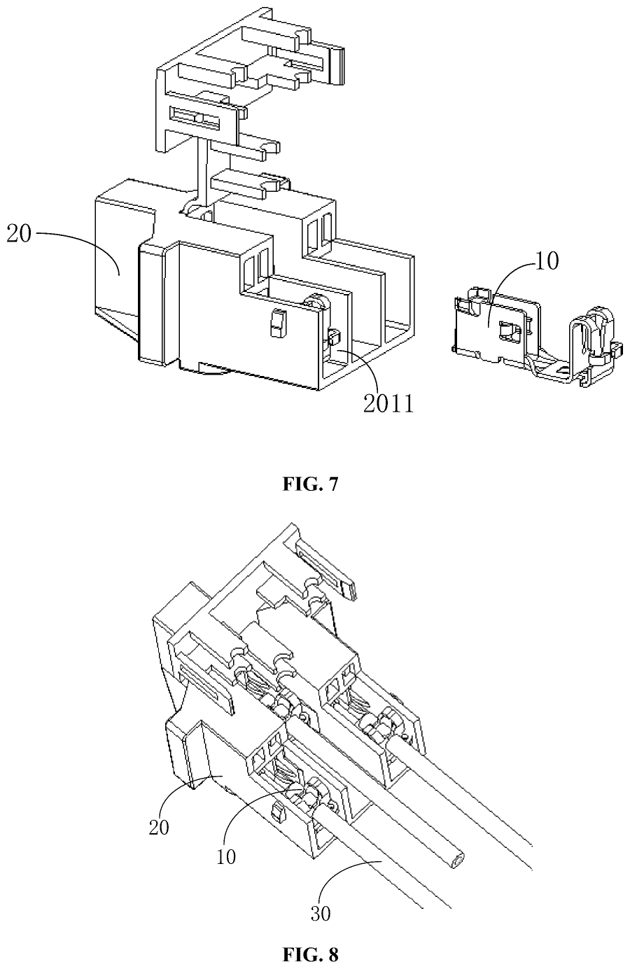

The assembly process of the connector assembly is briefly described below. First, referring to FIG. 7, the terminal 10 is placed in the accommodating channel 2011 of the connector housing 20. Subsequently, referring to FIG. 8, the wire 30 is pressed into the terminal 10 by using a wire pressing tool, so that the terminal 10 is electrically connected with the wire 30. Finally, referring to FIG. 4, the cover 202 of the connector housing 20 is flipped down to secure the wire 30 within the connector assembly. This assembly process can entirely rely on an automated implementation. Compared to the prior art, the assembly process does not have a wire stripping step, wherein the step of crimping and fixing the wire 30 can be performed by a machine. The use of such a connector assembly is beneficial to save assembly time and cost, and is more suitable for mass production.

In addition, the present disclosure further provides the terminal 10 for connecting the wire 30. Referring to FIG. 1, the terminal 10 includes the wire connecting portion 101 and the limiting portion 102. The wire connecting portion 101 can be used for electrical connection with a wire, and the limiting portion 102 is disposed on a side of the wire connecting portion 101. The limiting portion 102 is capable of being opposite to the blocking portion 2021 of the connector housing 20, thereby fixing the wire 30 between the blocking portion 2021 and the limiting portion 102. The terminal 10 can be used to realize automatic assembly and save assembly time and cost.

The limiting portion 102 includes the first limiting arm 1021 and the second limiting arm 1022 that are oppositely distributed. At least a portion of a distance between the first limiting arm 1021 and the second limiting arm 1022 is less than a diameter of the wire 30, preventing the wire 30 from moving downward.

Referring to FIG. 5, the wire connecting portion 101 of the terminal 10 includes the first pair of blade-type sub-arms 1011 distributed oppositely. When the wire 30 goes between the first pair of blade-type sub-arms 1011, the first pair of blade-type sub-arms 1011 achieves a piercing-type electrical connection with the wire 30 and clamps the wire 30 therebetween.

The wire connecting portion 101 further includes the second pair of blade-type sub-arms 1012 oppositely distributed, and the second pair of blade-type sub-arms 1012 is disposed along the extending direction of the wire 30 relative to the first pair of blade-type sub-arms 1011. When the wire 30 goes between the second pair of blade-type sub-arms 1012, the second pair of blade-type sub-arms 1012 achieves a piercing-type electrical connection with the wire 30 and clamps the wire 30 therebetween.

Referring to FIG. 1, the terminal 10 further includes a mating terminal connecting portion 105, and the mating terminal connecting portion 105 is configured to accommodate a mating terminal (e.g., a pin terminal) and achieve an electrical connection with the mating terminal.

As shown in FIG. 6, the terminal 10 further includes the terminal body 103 with the dovetail groove 1031 disposed thereon and the dovetail tenon 104. The terminal body 103 with a dovetail groove 1031 disposed thereon is directly connected to the first pair of blade-type sub-arms 1011, and the dovetail tenon 104 is directly connected to the second pair of blade-type sub-arms 1012. The dovetail tenon 104 is embedded in the dovetail groove 1031, such that the second pair of blade-type sub-arms 1012 is fixed relative to the first pair of blade-type sub-arms 1011.

For technical details of the terminal 10, reference may be made to the foregoing description of the terminal 10 in the connector assembly, and details are not described herein again.

It should be noted that only specific embodiments of the present invention are listed above, and it is apparent that the present disclosure is not limited to the above embodiments, and there are many similar therewith. Those skilled in the art should also realize that all modifications that are derived from or conceived based on the disclosure of the present invention shall belong to the scope of protection of the present invention.

1. A connector assembly, comprising:
a terminal including a wire connecting portion electrically connectable with a wire and a limiting portion disposed on a side of the wire connecting portion; and
a connector housing including a body having an accommodating channel accommodating the terminal and a cover movably disposed on the body with a blocking portion disposed on the cover, the cover is movably operated such that the blocking portion is opposite to the limiting portion, fixing the wire between the blocking portion and the limiting portion.

2. The connector assembly of claim 1, wherein the limiting portion includes a first limiting arm and a second limiting arm that are oppositely distributed.

3. The connector assembly of claim 2, wherein at least a portion of a distance between the first limiting arm and the second limiting arm is less than a diameter of the wire.

4. The connector assembly of claim 1, wherein the blocking portion has an arcuate notch disposed at an end of the blocking portion.

5. The connector assembly of claim 1, wherein the wire connecting portion includes a first pair of blade-type sub-arms distributed oppositely, and when the wire moves between the first pair of blade-type sub-arms, the first pair of blade-type sub-arms achieves a piercing electrical connection with the wire and clamps the wire therebetween.

6. The connector assembly of claim 5, wherein the wire connecting portion includes a second pair of blade-type sub-arms distributed oppositely, the second pair of blade-type sub-arms are disposed along an extending direction of the wire relative to the first pair of blade-type sub-arms.

7. The connector assembly of claim 6, wherein the second pair of blade-type sub-arms achieves a piercing electrical connection with the wire and clamps the wire therebetween when the wire moves between the second pair of blade-type sub-arms.

8. The connector assembly of claim 7, wherein the terminal includes a terminal body and a dovetail groove disposed thereon, the terminal body and the dovetail groove are directly connected to the first pair of blade-type sub-arms.

9. The connector assembly of claim 8, wherein the terminal includes a dovetail tenon directly connected to the second pair of blade-type sub-arms, the dovetail tenon is embedded in the dovetail groove to fix the second pair of blade-type sub-arms relative to the first pair of blade-type sub-arms.

10. The connector assembly of claim 1, wherein the blocking portion includes a first blocking portion and a second blocking portion, the second blocking portion is disposed along an extending direction of the wire relative to the first blocking portion.

11. The connector assembly of claim 1, wherein the cover is connected to the body through a hinge.

12. The connector assembly of claim 1, wherein the connector housing is integrally formed via a mold.

13. The connector assembly of claim 11, wherein the cover includes a snap-fit portion and the body includes a snap-fit mating portion, the snap-fit portion cooperates with the snap-fit mating portion to fix the cover on the body.

14. A terminal for connecting to a wire, comprising:
a wire connecting portion electrically connectable with the wire; and
a limiting portion disposed on a side of the wire connecting portion, the limiting portion is opposite to a blocking portion of a connector housing to fix the wire between the blocking portion and the limiting portion.

15. The terminal of claim 14, wherein the limiting portion includes a first limiting arm and a second limiting arm that are oppositely distributed, at least a portion of a distance between the first limiting arm and the second limiting arm is less than a diameter of the wire.

16. The terminal of claim 14, wherein the wire connecting portion includes a first pair of blade-type sub-arms distributed oppositely, and when the wire moves between the first pair of blade-type sub-arms, the first pair of blade-type sub-arms achieves a piercing electrical connection with the wire and clamps the wire therebetween.

17. The terminal of claim 16, wherein the wire connecting portion includes a second pair of blade-type sub-arms distributed oppositely, the second pair of blade-type sub-arms are disposed along an extending direction of the wire relative to the first pair of blade-type sub-arms.

18. The terminal of claim 17, wherein the second pair of blade-type sub-arms achieves a piercing electrical connection with the wire and clamps the wire therebetween when the wire moves between the second pair of blade-type sub-arms.

19. The terminal of claim 18, further comprising a terminal body and a dovetail groove disposed thereon, the terminal body and the dovetail groove are directly connected to the first pair of blade-type sub-arms.

20. The terminal of claim 19, further comprising a dovetail tenon directly connected to the second pair of blade-type sub-arms, the dovetail tenon is embedded in the dovetail groove to fix the second pair of blade-type sub-arms relative to the first pair of blade-type sub-arms.
